(19) United States
(12) Patent Application Publication
(10) Pub. No.: US 2018/0295793 A1
(43) Pub. Date: Oct. 18, 2018

(54) MULCH FILM WITH STRETCHING GUIDE AND METHOD OF USE

(71) Applicant: 9298-6876 QUÉBEC INC., Laval (CA)

(72) Inventors: ROGER TAMBAY, MONTREAL (CA); HUGO MEUNIER, LAVAL (CA)

(21) Appl. No.: 15/950,631

(22) Filed: Apr. 11, 2018

Related U.S. Application Data
(60) Provisional application No. 62/484,504, filed on Apr. 12, 2017.

(51) Int. Cl. A01G 13/02; C08J 7/04; C08J 5/18

(52) U.S. Cl. CPC A01G 13/0275; C08J 7/04; C08J 2323/06; C08J 2300/00; C08J 5/18

(57) ABSTRACT

A biodegradable, degradable or bio-polymer mulch film comprising a stretching guide operatively attached thereto is provided. The stretching guide may comprise a mark on a surface of the film or a built-in/integrated tension monitor. A method for manufacturing the mulch film and a method of using the mulch film are also provided.

This application claims benefit of U.S. provisional application Ser. No. 62/484,504, filed on Apr. 12, 2017. All documents above are incorporated herein in their entirety by reference.

### FIELD OF THE INVENTION

The present invention relates generally to biodegradable and degradable mulch films. More specifically, the invention relates to a biodegradable or degradable mulch film comprising a stretching guide (built-in tension monitor). The invention also relates to a method of laying such mulch film on a soil bed. The mulch film and method of the invention allow for a visual control of the film stretching (tension) across the bed during the laying process.

### BACKGROUND OF THE INVENTION

The use of mulch films is widespread in agriculture. In particular, biodegradable and degradable mulch films are used. For example, mulch films such as those disclosed in Applicant's patent application PCT/CA2016/051226 are used—the content of this patent application is herein incorporated by reference. The mulch films may, however, break down prematurely if they are over stretched (i.e., applied on the ground with too much tension). Instead of lasting between about 4-6 months, which is the average growing season in the mid-Atlantic region of the United States of America, over stretched films may last between about 1-2 months. Accordingly, the cost to grow field grown products rises exponentially. Indeed, the farmer pays for an ineffective mulch film and spends money on labour to clean the field of weeds which have grown because of the failed mulch film.

The prior art teaches that non-biodegradable mulch films, generally made from polyethylene film of about 0.5 milli-inches to about 2.5 milli-inches and optionally with an embossed surface, must be tightly stretched across the soil bed so as to avoid the film from ballooning on the bed and subsequently blowing off. Indeed, embossing the surface of the film effectively builds-in a spring-like feature that counteracts polyethylene's natural tendency to expand with heat in such an amount that induces the mulch film to bellow and blow off in the wind.

Regarding biodegradable mulch films, the prior art teaches applying the film loose on the ground, avoiding any stretching (i.e., no tension) [Bio360 document at http://www.duboisag.com/en/downloads/dl/file/id/9/biotelo_biodegradable_compostable_mul ch_fim_user_manual.pdf]. There are drawbacks associated to this technique. For example, it is difficult to punch a hole on a loose film, required for seeding or transplanting. Also, a mulch film that is applied loose is prone to blow off in the wind. The wind gets in under the film and lifts it from the ground. Moreover, planting (fragile) transplants in a ground covered with a loosely applied mulch film causes the film to rub against, and damage, the fragile transplant, causing lower yield of fruits or vegetables. The same is true for seeding.

It is generally desirable to plant from a soil bed. Such bed consists of a cluster of earth and/or other suitable materials provided on the ground as a parallelepiped or other suitable form. The planting surface is thus at a level above the ground surface. More specifically, a shoulder is provided between the ground surface and the planting surface. Typically, the planting surface is about 15 cm above the ground surface. Accordingly, upon laying a biodegradable much film on the planting surface along the bed, stretching of film (tension) across the bed occurs, particularly at the edge of the bed. This is due to the shoulder of the bed. At least some of such stretching (tension) is necessary for an efficient use of the biodegradable mulch film. However, a challenge for the farmer is to determine the suitable amount of stretching (i.e., suitable amount of tension) such as to avoid a premature break down of the biodegradable mulch film.

An alternate solution to the premature break down of a biodegradable mulch film is to increase the thickness of the film. This leads to more costly biodegradable mulch films.

There is a need for biodegradable mulch films that last during the entire growing season without breaking down prematurely, and that are cost-effective. Also, there is a need for methods of laying a biodegradable mulch film on a soil bed such as to allow for an optimal use of the film.

### SUMMARY OF THE INVENTION

The inventors have discovered a biodegradable mulch film comprising a stretching guide. Also, the inventors have discovered a method of laying a biodegradable mulch film on a soil bed. The biodegradable mulch film and method of the invention allow for a control of the film stretching (tension) across the soil bed during the laying process. The control is visual with no requirement of any control device.

In embodiments of the invention, the stretching guide comprises a mark and/or a built-in tension monitor or integrated tension monitor. The mark may be a geometrical form or other suitable form applied on a surface thereof, at at least one strategic location on the surface of the film. Also, the mark may consist of a set of letters applied at strategic locations on the surface of the film.

In embodiments of the invention, the laying of the biodegradable mulch film on the planting surface of the soil bed leads to the film being stretched across the bed causing the stretching guide to undergo a deformation. The user compares the stretched stretching guide to a set stretching guide provided which is indicative of an acceptable limit of stretching of the film (i.e., acceptable amount of tension for the film), and make sure to remain below or at the limit.

For example, in embodiments of the invention wherein the stretching guide is a mark, the user may compare the stretched mark to a set deformed mark provided or the user may mentally assess the variation. In embodiments of the invention wherein the stretching guide comprises a set of letters (or marks), the user may measure the distance between the letters and make sure that the distance remains below a set value. In embodiments of the invention wherein the stretching guide is a built-in tension monitor or integrated tension monitor, the user may visually monitor the tension monitor and make sure that its shape is substantially unchanged (tension monitor not deformed).

The method of the invention allows for an optimal use of a biodegradable mulch film. In particular, the mulch film of the invention lasts during substantially the entire growing season without breaking down prematurely.

The invention thus provides for the following according to aspects thereof:
(1) A biodegradable mulch film comprising a stretching guide operatively attached thereto.
(2) A biodegradable mulch film comprising a stretching guide operatively attached at at least one edge thereof.
(3) A biodegradable mulch film comprising a mark printed on a surface thereof.
(4) A biodegradable mulch film comprising a mark printed on a surface thereof at at least edge thereof.
(5) A biodegradable mulch film comprising a built-in tension monitor (integrated tension monitor).
(6) A biodegradable mulch film comprising a built-in tension monitor (integrated tension monitor) at at least one edge thereof.
(7) A biodegradable mulch film comprising a stretching guide, wherein, when the film is in a loose state the stretching guide has a first shape and when the film is a stretched state the stretching guide has a second shape.
(8) A biodegradable mulch film comprising a stretching guide at an edged thereof, wherein, when the film is in a loose state the stretching guide has a first shape and when the film is a stretched state the stretching guide has a second shape.
(9) A biodegradable mulch film comprising a mark printed on a surface thereof, wherein, when the film is in a loose state the mark has a first shape and when the film is a stretched state the mark has a second shape.
(10) A biodegradable mulch film comprising a mark printed on a surface thereof at an edged thereof, wherein, when the film is in a loose state the mark has a first shape and when the film is a stretched state the mark has a second shape.
(11) A biodegradable mulch film comprising a plurality of spaced-apart stretching guides operatively attached thereto.
(12) A biodegradable mulch film comprising a plurality of spaced-apart stretching guides operatively attached thereto at at least one edge thereof.
(13) A biodegradable mulch film comprising a plurality of spaced-apart marks printed on a surface thereof.
(14) A biodegradable mulch film comprising a plurality of spaced-apart marks printed on a surface thereof at at least one edge thereof.
(15) A process for manufacturing a biodegradable mulch film, comprising a step of operatively attaching a stretching guide to the film.
(16) A process for manufacturing a biodegradable mulch film, comprising a step of operatively attaching a plurality of spaced-apart stretching guides to the film.
(17) A process for manufacturing a biodegradable mulch film, comprising a step of printing at least one mark on the surface of the film.
(18) A process for manufacturing a biodegradable mulch film, comprising a step of printing a plurality of spaced-apart marks on the surface of the film.
(19) A method of laying a mulch film on the ground, wherein the method embodies a stretching guide operatively attached to the film.
(20) A method of laying a mulch film on the ground, wherein the method embodies a tension monitor built in the film (integrated to the film).
(21) A method of laying a biodegradable mulch film on a soil bed, comprising:
   (a) providing a mulch film having a stretching guide;
   (b) optionally, providing, separately to the film, a set deformed/stretched guide indicative of a stretching limit for the film;
   (c) laying the film on the soil bed, thereby causing the stretching guide to stretch across the soil bed;
   (d) comparing the stretched stretching guide on the stretched film to the set stretched guide provided; and
   (e) adjusting the film stretching according to the stretching limit.
(22) A method of laying a biodegradable mulch film on a soil bed, comprising:
   (a) providing a mulch film having a mark printed on a surface thereof;
   (b) optionally, providing, separately to the film, a set deformed/stretched mark indicative of a stretching limit for the film;
   (c) laying the film on the soil bed, thereby causing the mark to stretch across the soil bed;
   (d) comparing the stretched mark on the stretched film to the set stretched mark provided; and
   (e) adjusting the film stretching according to the stretching limit.
(23) A method of controlling the temperature of the soil and air around a plant or controlling weed pressure around a plant, comprising using a biodegradable mulch film comprising a stretching guide operatively attached thereto.
(24) A kit for use in agricultural activities, comprising: (a) a biodegradable mulch film having a stretching guide operatively attached thereto; (b) optionally, a set deformed/stretched guide indicative of a stretching limit for the film; and (c) optionally, instructions for using the biodegradable mulch film.
(25) A kit for use in agricultural activities, comprising: (a) at least one roll of a biodegradable mulch film having a plurality of spaced-apart stretching guides each operatively attached to the film; (b) optionally, a set deformed/stretched guide indicative of a stretching limit for the film; and (c) optionally, instructions for using the biodegradable mulch film.
(26) A biodegradable mulch film, process, method as defined in any one of (1) to (25) above, wherein the stretching guide comprises a mark (a geometrical form or any other suitable form), a set of marks, a set of letters, a built-in tension monitor (integrated tension monitor).
(27) A biodegradable mulch film, process, method as defined in any one of (1) to (26) above, wherein the stretching guide comprises a mark such as a circle.
(28) A biodegradable mulch film, process, method as defined in any one of (1) to (27) above, wherein the stretching guide comprises a plurality of spaced-apart marks and/or letters and/or built-in tension monitors.
(29) A biodegradable mulch film, process, method as defined in any one of (1) to (28) above, wherein the stretching guide is located on a surface of the film.
(30) A biodegradable mulch film, process, method as defined in any one of (1) to (29) above, wherein the stretching guide is located on a surface of the film at at least one edge thereof.
(31) A biodegradable mulch film, process, method as defined in any one of (1) to (30) above, wherein the stretching guide comprises a plurality of spaced-apart marks and/or letters and/or tension monitors located at various locations on a surface of the film.
(32) A biodegradable mulch film, process, method as defined in any one of (1) to (31) above, wherein the stretching guide comprises a plurality of spaced-apart marks and/or letters and/or tension monitors located at various locations on a surface of the film, at at least one edge thereof.
(33) A biodegradable mulch film, process, method as defined in any one of (1) to (32) above, wherein the surface of the film comprising the stretching guide is the top surface or air surface.
(34) A process for manufacturing a bio-polymer mulch film, comprising: (a) coating at least parts of a surface of a bio-polymer film with a functional material; and (b) operatively attaching a stretching guide to the film.
(35) A process for manufacturing a bio-polymer mulch film, comprising: (a) providing a film of bio-polymer material; (b) coating at least parts of a surface of the bio-polymer film with a functional material to obtain the bio-polymer mulch film; and (c) operatively attaching a stretching guide to the film.
(36) A bio-polymer mulch film comprising: (a) a layer of bio-polymer material that is at least partially coated with a layer of a functional material; and (b) a stretching guide operatively attached thereto.
(37) A method of controlling the temperature of the soil and air around a plant or controlling weed pressure around a plant, comprising using a bio-polymer mulch film comprising a layer of bio-polymer material that is at least partially coated with a layer of a functional material, and a stretching guide operatively attached thereto.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIGS. 1A and 1B: Picture of the biodegradable mulch film (loose) according to the invention with a circle (stretching guide) printed thereon.

FIG. 2: Picture of the biodegradable mulch film (as may be stretched across a soil bed) showing the circle (stretching guide) stretched/deformed, not acceptable.

FIG. 3: Picture of the biodegradable mulch film (as may be stretched across a soil bed) showing the circle (stretching guide) stretched/deformed, acceptable.

FIG. 4: Picture of the biodegradable mulch film (as may be stretched across a soil bed) showing the circle (stretching guide) stretched/deformed, after adjustment for example from FIG. 2, acceptable.

FIG. 5 and FIG. 6: Picture of the biodegradable mulch film showing a plurality of circles (stretching guides) at various locations on the surface of the film.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments, and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this invention pertains.

As used herein the term “stretching guide” refers to a mark embodied with the biodegradable mulch film and which may undergo stretching during the process of laying the film on a soil bed. which may be a geometrical form or any other suitable form. The stretching guide may comprise at least one mark (geometrical form or any other suitable form) or letter. The stretching guide may also comprise a built-in tension monitor or integrated tension monitor.

As used herein the term “biodegradable mulch film” refers to a film having a composition consisting primarily of ingredients that meet ASTM D-6400 standards. Also, the term refers to a film that is intended to decompose into biomass and water primarily through microbial activity. Moreover, the term refers to polyethylene films which contain a pro-degradant, so called “oxo-degradable”, “photo-degradable” and semi-degradable films; these films are not called biodegradable films because it has not been proven that they fully biodegrade, rather they simply degrade into fine polyethylene, i.e., a quick reduction of molecular weight occurs when exposed to sunlight.

As used herein the term “degradable mulch film” refers to a film that is intended to break down in the field within about a 3-year period, whether it be through full or partial bio-chemical means. The term also refers to films made using mostly ingredients that meet ASTM D-6400 standards. Moreover, the term refers to films that meet level 1 of ASTM D-6954 standards in connection with disintegration, as well as films that meet the ASTM D-7081 or ASTM D-6868 or EN-13432 or ISO 17088 standard.

As used herein the term “soil bed” refers to a cluster of earth and/or other suitable materials provided on the ground as a parallelepiped or other suitable form of at least about 2 inches in height; a shoulder is provided between the ground surface and the planting surface, and the planting surface is at a level above the ground surface.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, un-recited elements or process steps.

As used herein the term “about” is used to indicate that a value includes an inherent variation of error for the device or the method being employed to determine the value.

The inventors have discovered a biodegradable mulch film comprising a stretching guide. Also, the inventors have discovered a method of laying a biodegradable mulch film on a soil bed. The biodegradable mulch film and method of the invention allow for a control of the film stretching (tension) across the soil bed during the laying process. The control is visual with no requirement of any control device.

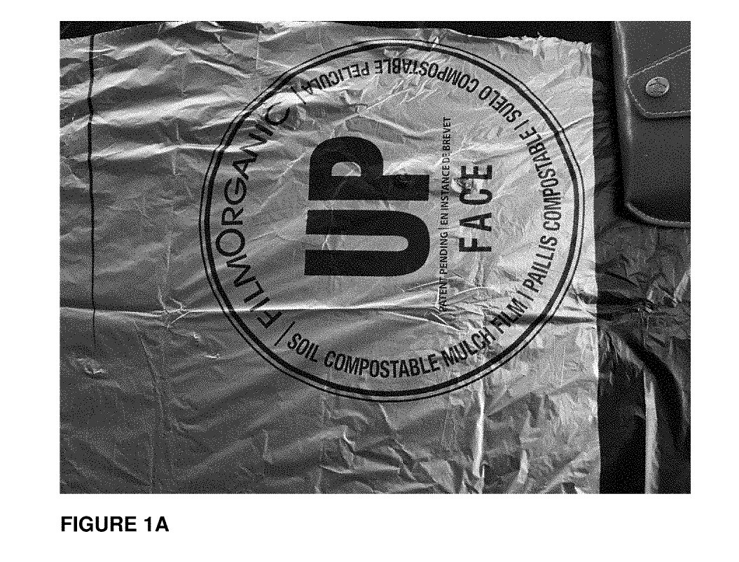

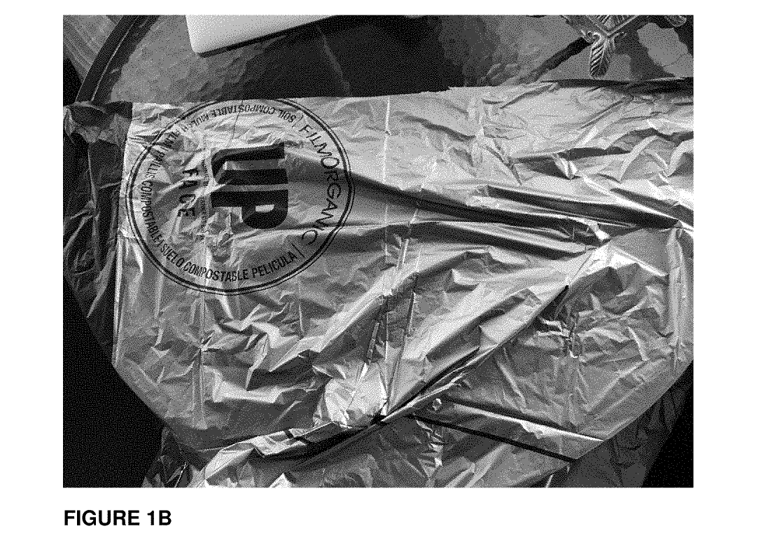

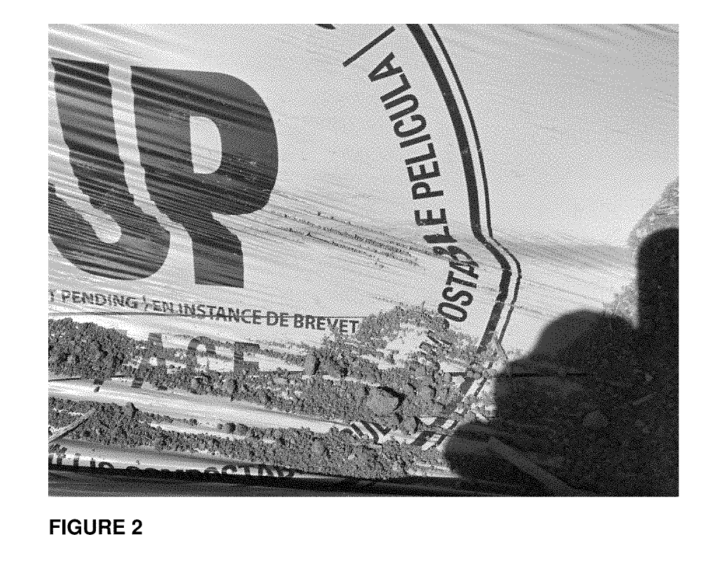

Referring to the figures, a circle is printed on the biodegradable mulch film. When the film is in the loose state, the circle has its regular/normal shape (FIGS. 1A and 1B). If the film is stretched in cross-sectional direction, the circle is deformed and its shape becomes substantially oval at least at parts thereof (FIG. 2). The biodegradable mulch film may be provided together with a set deformed circle (oval shape) which indicates the limit of an acceptable deformation (acceptable stretching, acceptable maximum tension). As will be understood by a skilled person, the set deformed circle is provided as a visual guide and is separate from the film. In embodiments of the invention, no set deformed circle is provided and the farmer mentally assesses the acceptable deformation limit (for example a deformation of about 1-2% may be acceptable).

In embodiments of the invention wherein the stretching guide consists of a set of letters (or marks), the farmer may measure the distance between the letters and make sure that the distance remains below a set value. Alternatively, the farmer may mentally assess the acceptable distance (for example a variation of about 1-2% may be acceptable).

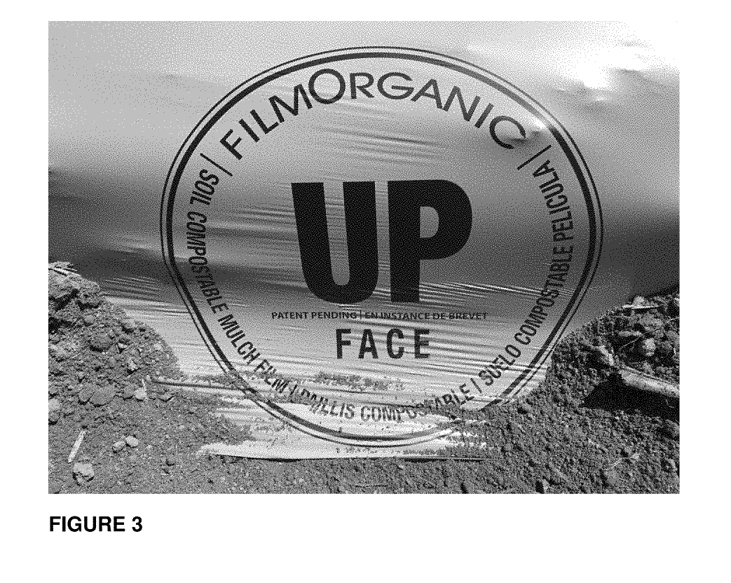

In embodiments of the invention wherein the stretching guide is a built-in tension monitor or integrated tension monitor, the user may visually monitor the tension monitor and make sure that its shape is substantially unchanged or changed to an acceptable level (tension monitor substantially not deformed or deformed to an acceptable limit). This is illustrated for example in FIG. 3.

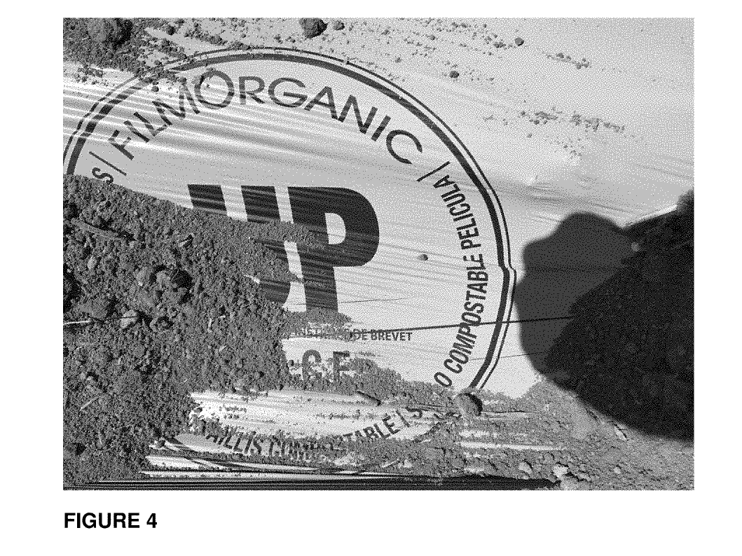

During the laying process, by visual inspection, the farmer compares the stretched/deformed circle on the biodegradable mulch film being applied on the soil bed and the set deformed circle provided. If the deformation of the circle on the film is more pronounced than the deformation on the visual guide (set deformed circle) provided, the farmer adjusts the stretching (tension) accordingly (FIG. 4). This may include adjusting the settings of a machine or equipment being used for laying the film.

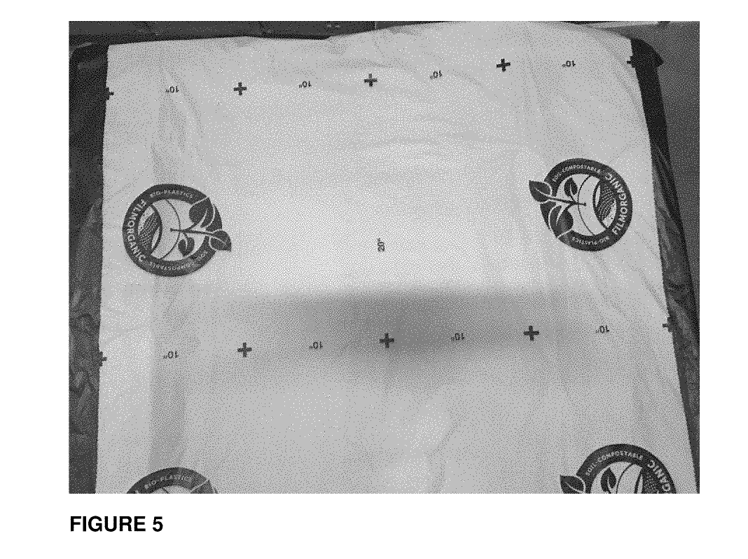

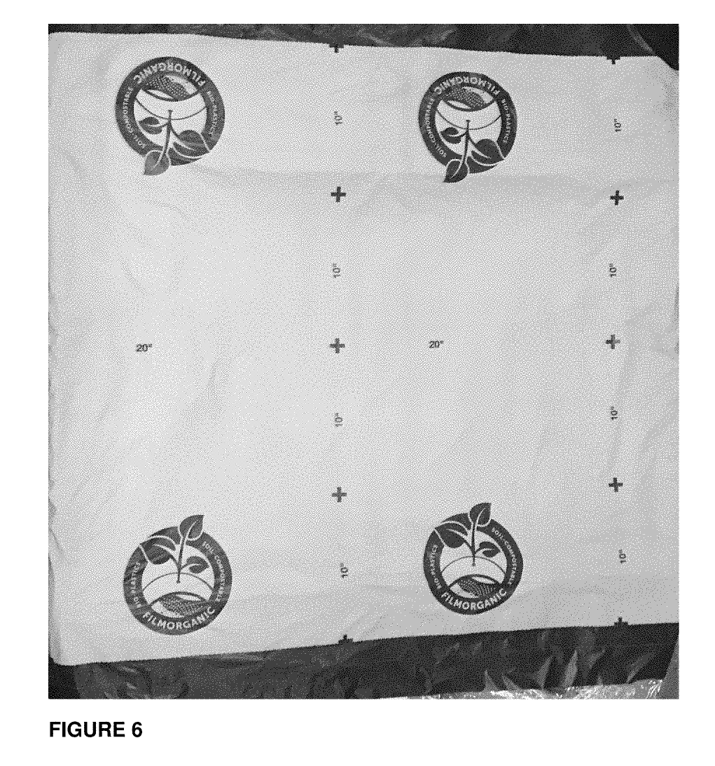

FIG. 5 and FIG. 6 show embodiments of the invention wherein the film comprises a plurality of circles provided on the surface of the film.

As will be understood by a skilled person, the mulch film may be any suitable biodegradable or degradable mulch film used by farmers. In embodiments of the inventions, the mulch films are biodegradable mulch films such as for example those disclosed in Applicant's patent application PCT/CA2016/051226. The content of this application is herein incorporated by reference.

In embodiments of the invention, the circle is located substantially at an edge of the film, such that it falls on the shoulder of the soil bed. The circle may be located at more than one edges of the film. For example, one circle may be provided on each edge. As will be understood by a skilled person, the circle is repeated along the film, at a suitable interval such as to allow for a continuous monitoring during the laying process. For example, for a 5000′ roll of biodegradable mulch film, a circle may be provided at a repeat of about every 24″. Preferably a circle is provided at about every 50 feet.

As will be understood by a skilled person, the circle may be located at another suitable location along the biodegradable mulch film, such location allowing for the circle to undergo a stretching (tension) upon contacting the shoulder of the soil bed, such location also allowing for a visual inspection by the farmer.

As will be understood by a skilled person, the stretching guide (circle in the figures) may consist of any mark, a geometrical form or other suitable form. A corresponding set deformed mark is optionally provided, separately for comparison by the farmer (guidance).

As will be understood by a skilled person, the mark is large enough such as to allow for a visual inspection by the farmer from a distance of at least about 3 meters or more.

In embodiments, the mark is printed on the surface of the biodegradable mulch film. As will be understood by a skilled person, other suitable operative attachment means may be used. Such attachment allows for the mark to undergo a deformation/stretching during the laying process when the mulch film contacts the shoulder of the soil bed (i.e., when tension is created on the film, particularly at the edge thereof).

In embodiments of the invention wherein a built-in tension monitor or integrated tension monitor is used, attachment of the tension monitor to the film is such that stretching of the tension monitor is indicative of an over-stretching of the film (i.e., the stretching limit of the film is reached).

As will be understood by a skilled person, adjustment of the stretching (tension) of the mulch film by the farmer may comprise adjusting the settings of an equipment being used to lay the mulch film on the soil bed. Such equipment may be any suitable equipment known in the art for applying a mulch film in the field.

### INDUSTRIAL APPLICABILITY

There is provided a mulch film and method allowing for an efficient and cost-effective use of the film. Indeed, the invention allows for the mulch film to last substantially the entire growing season without breaking.

Although the present invention has been described hereinabove by way of specific embodiments thereof, it may be modified, without departing from the spirit and nature of the subject invention as defined in the appended claims.

The present description refers to a number of documents, the content of which is herein incorporated by reference in their entirety.

1. A biodegradable mulch film comprising a stretching guide operatively attached thereto.

2. A biodegradable mulch film according to claim 1, wherein the stretching guide is attached at at least one edge thereof.

3. A biodegradable mulch film according to claim 1, wherein the stretching guide is located on a surface of the film; optionally, said surface is the top surface or air surface of the film.

4. A biodegradable mulch film according to claim 1, wherein, when the film is in a loose state the stretching guide has a first shape and when the film is a stretched state the stretching guide has a second shape.

5. A biodegradable mulch film according to claim 1, wherein the stretching guide comprises a mark printed on a surface of the film, or the stretching guide comprises a built-in tension monitor (integrated tension monitor).

6. A biodegradable mulch film according to claim 5, wherein the mark comprises a geometrical form or any other suitable form and/or a letter; optionally, the mark comprises a circle.

7. A biodegradable mulch film comprising a plurality of marks or a plurality of built-in tension monitors (integrated tension monitors) operatively attached thereto.

8. A biodegradable mulch film according to claim 7, wherein the marks or built-in tension monitors are attached at at least one edge of the film.

9. A biodegradable mulch film according to claim 7, wherein the marks or built-in tension monitors are located at various locations on a surface of the film; optionally, said surface is the top surface or air surface of the film.

10. A process for manufacturing a biodegradable mulch film as defined in claim 1, comprising a step of operatively attaching a stretching guide to a biodegradable mulch film.

11. A method of laying a biodegradable mulch film on a soil bed, comprising:
(a) providing a mulch film as defined in claim 1;
(b) optionally, providing, separately to the film, a set deformed/stretched guide indicative of a stretching limit for the film;
(c) laying the film on the soil bed, thereby causing the stretching guide to stretch across the soil bed;
(d) comparing the stretched stretching guide on the stretched film to the set stretched guide provided; and
(e) adjusting the film stretching according to the stretching limit.

12. A method of laying a biodegradable mulch film on a soil bed, comprising:
(a) providing a mulch film as defined in claim 5 which comprises the mark;
(b) optionally, providing, separately to the film, a set deformed/stretched mark indicative of a stretching limit for the film;
(c) laying the film on the soil bed, thereby causing the mark to stretch across the soil bed;
(d) comparing the stretched mark on the stretched film to the set stretched mark provided; and
(e) adjusting the film stretching according to the stretching limit.

13. A method of controlling the temperature of the soil and air around a plant or controlling weed pressure around a plant, comprising using a biodegradable mulch film as defined in claim 1.

14. A kit for use in agricultural activities, comprising: (a) a biodegradable mulch film as defined in claim 1; (b) optionally, a set deformed/stretched guide indicative of a stretching limit for the film; and (c) optionally, instructions for using the biodegradable mulch film.

15. A kit for use in agricultural activities, comprising: (a) at least one roll of a biodegradable mulch film as defined in claim 1; (b) optionally, a set deformed/stretched guide indicative of a stretching limit for the film; and (c) optionally, instructions for using the biodegradable mulch film.

16. A bio-polymer mulch film comprising: (a) a layer of bio-polymer material that is at least partially coated with a layer of a functional material; and (b) a stretching guide operatively attached thereto.

17. A process for manufacturing a bio-polymer mulch film at defined in claim 16, comprising: (a) providing a film of bio-polymer material; (b) coating at least parts of a surface of the bio-polymer film with a functional material to obtain the bio-polymer mulch film; and (c) operatively attaching a stretching guide to the coated film.

18. A method of controlling the temperature of the soil and air around a plant or controlling weed pressure around a plant, comprising using the bio-polymer mulch film as defined in claim 16.

19. A kit for use in agricultural activities, comprising: (a) a bio-polymer mulch film as defined in claim 16; (b) optionally, a set deformed/stretched guide indicative of a stretching limit for the film; and (c) optionally, instructions for using the bio-polymer mulch film.

20. A method of controlling the temperature of the soil and air around a plant or controlling weed pressure around a plant, comprising using a bio-polymer mulch film as defined in claim 16.
